(19) United States
(12) Patent Application Publication
(10) Pub. No.: US 2003/0233560 A1
(43) Pub. Date: Dec. 18, 2003

(54) Method for protecting program in microcomputer

(76) Inventor: Mitsuhiro Watanabe, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/365,460

(22) Filed: Feb. 13, 2003

(30) Foreign Application Priority Data
Jun. 14, 2002 (JP) 174114/2002

(51) Int. Cl. G06F 12/14

(52) U.S. Cl. 713/190

(57) ABSTRACT

A method for protecting a program in a microcomputer wherein analysis of the program by a third party is made difficult. It is configured that at least one region of the program enclosed by a memory 2 is enciphered, and the program is enclosed by a memory 2 together with a key necessary for the decode thereof, and the enciphered region is decoded using the key with a decode circuit 5 at the time when the enciphered region is accessed, and the decoded program data is outputted to a CPU 1.

### BACKGROUND OF THE INVENTION

1. Field of the Invention

The present invention relates, in a microcomputer system, to a method for protecting a program by means of making the program, which is enclosed by a memory, difficult to be physically analyzed.

2. Description of the Related Art

In a conventional microcomputer system, although the contents of a program not enciphered has been made not to be outputted via terminals of a chip so that the contents of the program cannot be analyzed by a third party, there has still been a danger of the contents' of the program being extracted by setting electrodes on the data output terminals and by giving an address to the memory with any available means because of lacking the consideration for physical analyzing means such as a probe method (a process of observing signals attaching fine electrodes to the wirings under a microscope).

However, in a microcomputer system for a security use such as an IC card in which information about money or personal privacy is stored, protection of a program is essential because there is a possibility of illegal conducts such as tampering with the data once the program is analyzed by a third party.

### SUMMARY OF THE INVENTION

The present invention provides a-method for protecting a program in a microcomputer wherein analysis of the program is made difficult for a third party. For that purpose at least a region of the program is enciphered, being enclosed in a memory together with a key necessary for decoding, and is configured to be decoded using the key when the enciphered region is accessed.

### BRIEF DESCRIPTION OF THE DRAWINGS

FIG. 1 is a block diagram of a microcomputer system showing a 1st embodiment of the present invention,

FIG. 2 is a block diagram of a microcomputer system showing a 2nd embodiment of the present invention.

### DETAILED DESCRIPTION OF THE INVENTION

In the following, the embodiments of the present invention will be described referring to the drawings. Besides, in the drawings, the size, the shape and the configuration of each constituent are shown only so schematically as to understand the present invention, and numerical requirements described below are given as mere illustrations.

[1st Embodiment]

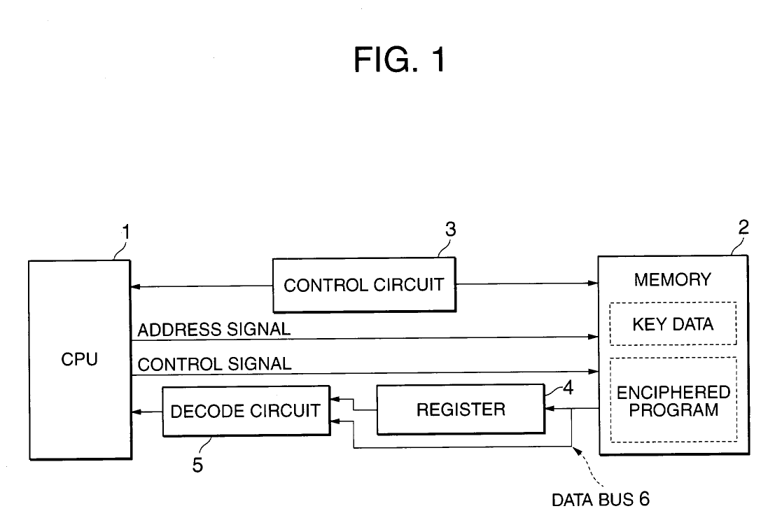

FIG. 1 is a block diagram of a microcomputer system showing a 1st embodiment of the present invention, and the system comprises: a CPU 1 being a main part for executing a program; a memory 2 for holding data acting as a key (a decoding key) and a enciphered program decodable with the key; a control circuit 3 for controlling the read-out of the key data from the memory 2 at an appropriate time e.g. after resetting the system; a register 4 for holding the key data read out from the memory 2; a decode circuit 5 for decoding the data outputted from the memory 2 using the key data enclosed in the register 4 to output the decoded data to the CPU 1; and a data bus 6.

The memory 2 outputs the program data shown by the key data or the address values to the data bus 6 on the basis of an address signal and a control signal outputted from the CPU 1.

A variety of methods can be employed for an enciphering method and a decoding method. As an example easy to be realized into a circuit, there is a method of enciphering by calculating an exclusive-or of every bit of the program data and the key data, and decoding can be realized in a similar way.

Besides, the following methods, for example, can be thought of: (a) a method of replacing one specified bit of the program data with another bit; (b) a method of inverting specified bits of the program data; (c) a method of rotating bit patterns of the program data in the right or left direction (the most significant bit is regarded as being adjacent to the least significant bit); (d) a method of combining a plurality of the above methods.

In the following, operations after resetting the microcomputer system as a whole will be described.

(1) The control circuit 3 demands that the memory 2 reads out the key data while the CPU 1 is in a wait state (a state where execution of the program is waited for).

(2) The key data is outputted from the memory 2 to the data bus 6 and the register 4 holds the data on the data bus 6.

(3) The control circuit 3 releases the wait state of the CPU 1 and the CPU turns to be in an executable state.

(4) Every time the CPU 1 fetches an instruction, the decode circuit 5 performs decoding operation between the key data enclosed in the register 4 and the data on the data bus 6, and outputs the decoded data to the CPU 1.

According to the 1st embodiment as mentioned above, only the enciphered program data appear at a data output terminal and therefore a third party cannot get to know the contents of the program even if he tries to extract the data from the output terminal of the memory with a probe, and consequently secrecy of the program can be enhanced compared to that in any conventional systems.

[2nd Embodiment]

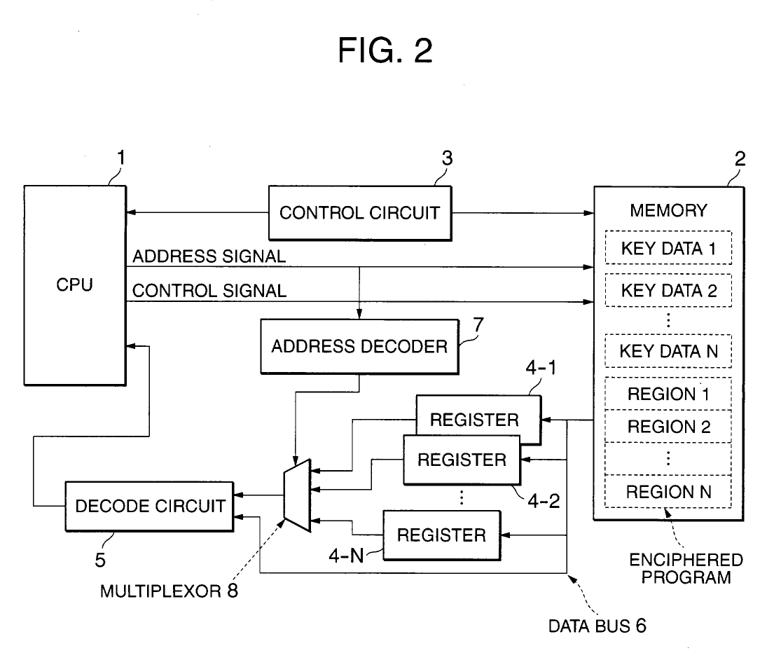

FIG. 2 is a block diagram of a microcomputer system showing a 2nd embodiment of the present invention and features, which are different in the constitution from those of the 1st embodiment, are that an encipherment region enclosed in the memory 2 is divided in to a plurality of regions 1 to N providing key data 1 to N corresponding to each region, and that providing registers 4-1 to 4-N for enclosing the corresponding key data 1 to N therein when reading out the data from each enciphered region, a multiplexor 8 is also included as a constituent in order to select the register 4 corresponding to the region read out through deciphering the addresses using an address-decoder 7.

Similar methods as those in the 1st embodiment can be employed for methods of enciphering and decoding processes.

In the following, operations after resetting the microcomputer system as a whole will be described.

(1) The control circuit 3 demands that the memory 2 reads out the key data while the CPU 1 is in a wait state (a state where execution of the program is waited for).

(2) The key data is outputted from the memory 2 to the data bus 6 and the register 4 holds the key data corresponding to each region of the enciphered program on the data bus 6 in each register.

(3) The control circuit 3 releases the wait state of the CPU 1 and the CPU turns to be in an executable state.

(4) Every time CPU 1 fetches an instruction, selected is the register corresponding to the program region specified by the address value among the registers 4-1 to 4-N by means of the address-decoder 7 and the multiplexor 8, and the key data is outputted to the decode circuit.

(5) The decode circuit 5 performs decoding operation between the key data and the data on the data bus 6, and outputs decoded data to the CPU 1.

According to the 2nd embodiment as mentioned above, by means of dividing the program region in to a plurality of regions to encipher or decode each region using individual key, decoding of the entire program region turns difficult without information about each program region. The reason is because, even if one region of the program is broken, it is impossible to break the other region using the decode key as the key data are different in each region. Thereby, it becomes possible to enhance secrecy of the program further.

Besides, the present invention should not be limited to each embodiment above but can be changed into various forms on the basis of the gist of the present invention.

(1) In order to protect key data themselves, the key data are enciphered for being retained in a memory. In the case above, keys for decoding the key data and a decode method thereof are realized by composing them as a combinational circuit. Usually, it is recognized that specifying a decode circuit in a combinational circuit on an LSI and analyzing the decode circuit are more difficult than probing a memory block for a third party. Consequently, secrecy of the program is enhanced much higher. Besides, the same algorithm as that for the main part of the program may be used for encipherment and decode of the key data.

(2) Although the entire region of a program region is taken as an object of encipherment in the 1st embodiment, a method of not enciphering a part of the region intentionally can be also employed. For example, since in an interrupt vector region or in an extremely small program region executed by a CPU immediately after resetting the system as a whole usually located often is a branch instruction or a control instruction, basic influence is thought to be sufficiently small as long as the main part of the program has been enciphered even if the programs enclosed in such regions are broken. On the contrary, by employing such a manner above, namely by intentionally excluding the region which is liable to be guessed or which is not cared about being guessed from an object of encipherment, it can be made difficult for a third party to decide whether the program concerned is enciphered or not, and secrecy of the program can effectively enhanced further.

As described in details above, according to the present invention, since it is configured that at least one region of the program is enciphered, and the program is enclosed by a memory together with a key necessary for the decode thereof, and said enciphered region is decoded using said key at the time when the region is accessed, secrecy of the program can be enhanced compared to that in any conventional systems.

What is claimed is:

1. A method for protecting a program in a microcomputer, the method comprising enciphering at least one region of the program, enclosing the program in a memory together with a key necessary for the decode thereof, and decoding said enciphered region using said key at the time when the region is accessed.

2. The method of claim 1 wherein said key is an enciphered key.

3. The method of claim 1, further comprising dividing the program region into a first program region necessary for initialization of the microcomputer system and a second program region excluding the first one, enciphering only said second program region, and acquiring the decode key within the period between completion of the initialization process and transfer of the control process to said second program region.

4. The method of claim 2, further comprising dividing the program region into a first program region necessary for initialization of the microcomputer system and a second program region excluding the first one, enciphering only said second program region, and acquiring the decode key within the period between completion of the initialization process and transfer of the control process to said second program region.
